(19) United States
(12) Patent Application Publication
(10) Pub. No.: US 2008/0199230 A1
(43) Pub. Date: Aug. 21, 2008

(54) Apparatus and method for fixing photocurable inks and printing apparatus

(75) Inventor: Masakazu Kawano, Ibaraki-ken (JP)

Correspondence Address: NATH & ASSOCIATES, 112 South West Street, Alexandria, VA, 22314, US

(73) Assignee: RISO KAGAKU CORPORATION, Tokyo (JP)

(21) Appl. No.: 12/081,533

(22) Filed: Apr. 17, 2008

Related U.S. Application Data
(62) Division of application No. 10/529,204, filed on Mar. 25, 2005, now abandoned.

(30) Foreign Application Priority Data
Sep. 27, 2002 (JP) 2002-282477

(51) Int. Cl. G03G 15/20

(52) U.S. Cl. 399/322

(57) ABSTRACT

An apparatus for fixing photocurable inks includes: a light source for irradiating light for fixation to a recording side of a recording medium printed with photocurable ink; a fixing member which is disposed in a conveyance path of the printed recording medium, is formed in a cylindrical shape, and can transmit the light for fixation; a conveying member disposed so as to face the fixing member over the conveyance path; and a pressurizing unit for nipping the fixing member and the conveying member. The recording medium is conveyed between the fixing member and the conveying member which are nipped by the pressurizing unit, the fixing member and the recording side of the recording medium are made come into tight contact with each other, and a contact part between the fixing member and the recording side of the recording medium is irradiated by the light for fixation which transmits the fixing member to thereby cure/fix the photocurable ink on the recording side of the recording medium.

### TECHNICAL FIELD

The present invention relates to an apparatus and method for fixing photocurable inks and a printing apparatus for performing printing with photocurable inks.

### BACKGROUND ART

Heretofore, in a printing apparatus such as a stencil printing apparatus or an ink jet printing apparatus, printing with photocurable inks is performed. Japanese Patent Application Laid-Open Publication No. 2001-171221 discloses a printing apparatus in which photocurable ink is cured by irradiation (illumination) of light. In a printing apparatus with the photocurable ink, photocurable ink immediately after being printed on a printing sheet can be cured and fixed by light irradiation in relatively short time and, for example, so-called “strike-through (or set off)” where undried ink on a printing side of one printing sheet is transferred to a rear side of another printing sheet during continuous printing and the like can be prevented.

The photocurable ink includes an ultraviolet-curable ink (referred to as “UV ink”) that is cured by being irradiated by ultraviolet light (referred to as “UV light”). Generally, in a printing apparatus with the UV ink, a fixing apparatus for irradiating UV light is disposed at the back part of a printing unit, a printing sheet on which printing is performed with the UV ink and which is ejected from the printing unit is conveyed to a fixing apparatus, and a printing side of the printing sheet is irradiated by the UV light, thereby curing and fixing the UV ink.

However, such a fixing apparatus needs a number of components such as an air cooling fan and an exhaust duct for forcefully cooling heat generated from a UV lamp, a shutter mechanism for opening/closing the fixing apparatus as necessary, and a block plate for preventing leakage of the UV light to the outside of the fixing apparatus, so that the size of the fixing apparatus is, generally, a few times as large as the size of an irradiation area.

In addition, with respect to a power supply unit for the UV lamp or cooling unit, when the size of the irradiation area increases, for example, the power of 200V becomes necessary. It causes limitations in mounting places, sales contacts, and the like of the fixing apparatus.

Inks having low light transmittance such as black color need larger curing energy than inks having high light transmittance such as yellow color or blue color. Therefore, the fixing apparatus has to emit light of curing energy sufficiently large to cure and fix inks having low light transmittance such as black color. It causes increase in the cost of the power supply unit, cooling unit, and the like and the scale.

### DISCLOSURE OF THE INVENTION

The present invention has been made to solve such a problem and its object is to provide an apparatus and method of fixing photocurable inks and a printing apparatus realizing reduced photocurable energy required to cure and fix photocurable inks in a printing process with the photocurable ink.

According to an embodiment of the present invention, there is provided an apparatus for fixing photocurable inks, comprising: a light source for irradiating light for fixation to a recording side of a recording medium printed with photocurable ink; a fixing member which is disposed in a conveyance path of the printed recording medium, is formed in a cylindrical shape, and can transmit the light for fixation; a conveying member disposed so as to face the fixing member over the conveyance path; and a pressurizing unit for nipping the fixing member and the conveying member, wherein the recording medium is conveyed between the fixing member and the conveying member nipped by the pressurizing unit, the fixing member and the recording side of the recording medium are made come into tight contact with each other, and a contact part between the fixing member and the recording side of the recording medium is irradiated by the light for fixation which transmits the fixing member to thereby cure/fix the photocurable ink printed on the recording side of the recording medium.

A method for fixing photocurable ink according to an embodiment of the present invention, there is provided a method including the steps of: conveying a recording medium printed with photocurable ink in a conveyance path while nipping a fixing member which is disposed in the conveyance path of printed recording medium, is formed in a cylindrical shape, and can transmit a light for fixation and a conveying member disposed so as to face the fixing member over the conveyance path by a pressurizing unit, and making the fixing member and a recording side of the recording medium come into tight contact with each other; and irradiating the light for fixation, which transmits the fixing member, to a contact part between the fixing member and the recording side of the recording medium to thereby cure/fix the photocurable ink printed on the recording side of the recording medium.

Further, according to an embodiment of the present invention, there is provided a printing apparatus comprising: a printing unit which performs printing on a recording side of a recording medium with photocurable ink; a light source for irradiating light for fixation to the recording side of the recording medium printed by the printing unit; a fixing member disposed in a conveyance path of the printed recording medium, and which is formed in a cylindrical shape, and transmit the light for fixation; a conveying member disposed so as to face the fixing member over the fixing member; and a pressurizing unit for nipping the fixing member and the conveying member, wherein the recording medium is conveyed between the fixing member and the conveying member nipped by the pressurizing unit, the fixing member and the recording side of the recording medium are made come into tight contact with each other, and a contact part between the fixing member and the recording side of the recording medium is irradiated by the light for fixation which transmits the fixing member to thereby cure/fix the photocurable ink on the recording side of the recording medium.

It is generally known that oxygen disturb the photocurable reaction, and thereby fixing of photocurable ink is prevented. With the configuration of the present invention, however, by conveying the recording medium printed with the photocurable ink between the fixing member and the conveying member nipped by the pressurizing unit, and the fixing member and the recording side of the recording medium are in tight contact with each other. Therefore, in the contact part between the fixing unit and the recording side of the recording medium, the photocurable ink is directly irradiated by light for fixation that transmits the fixing member. In other words, the photocurable ink on the recording side is cured/fixed in a state where air (oxygen) is blocked, so that the photocurable energy necessary for curing/fixing can be reduced as compared with the case where the photocurable reaction occurs in air.

Meanwhile, the “recording medium” denotes a printable medium on which an image is printed with photocurable ink, is not limited to printing sheet and includes various materials such as cloth, plastic film sheet, metal plate, ceramics, glass, wood, and the like.

Each of the fixing member and the conveying member may be supported so as to be rotatable around its rotary shaft, the rotary shaft may be disposed in a direction orthogonal to a conveyance direction of the printable medium, and overall length in the rotary shaft direction may be equal to or larger than width in the direction orthogonal to the conveyance direction of the printable medium. With the configuration, the fixing member and the printable medium are in line contact with each other in the direction of the width of the printable side of the printable medium. By irradiating the line contact part of the printable side by the light for fixation while conveying the printable medium which is being pressed against the fixing member by the pressurizing member, oxygen that disturbs the photocurable reaction is blocked, and whereby the photocurable ink can be efficiently cured/fixed.

Peripheral velocity of the fixing member and the conveying member is equal to conveyance speed of printed medium.

The light source may be disposed on the outside of the fixing member, and the light for fixation may be incident on the fixing member from the side opposite to the nipped part of the fixing member and the conveying member, transmit the fixing member, and the contact part between the fixing member and the printable side of the printable medium is irradiated by the light for fixation.

The apparatus for fixing photocurable ink may further include a condensing unit for condensing the light for fixation, and the condensing unit is disposed between the light source and the fixing member and condenses light for fixation emitted from the light source so as to be incident on the fixing member.

The fixing member may be formed in a cylindrical shape, the light source may be disposed in the fixing member, and the contact part between the fixing member and the printable side of the printable medium may be irradiated by the light for fixation that transmits the fixing member.

By making the fixing member of quartz glass having high transmittance in the wavelength bands of the ultraviolet light waveband, the visible light waveband, and the infrared light waveband, the fixing member efficiently transmits the light for fixation from the light source and the printable side of the printable medium can be irradiated by the light for fixation.

The apparatus for fixing photocurable ink may further include a driving unit which rotates the fixing member and the fixing member may convey the printable medium by being rotary driven by the driving unit.

The photocurable ink is, for example, ultraviolet-curing radical polymerization ink (UV ink) and, in this case, the light for fixation is ultraviolet light.

### BRIEF DESCRIPTION OF THE DRAWINGS

FIG. 1 is a schematic side view showing part of a printing unit and a fixing apparatus in a stencil printing apparatus illustrated in FIG. 3.

FIG. 2 is a schematic perspective view of the fixing apparatus in the stencil printing apparatus illustrated in FIG. 3.

FIG. 3 is a schematic side view illustrating the stencil printing apparatus in a first embodiment.

FIG. 4 is an explanatory diagram illustrating a state where UV ink is cured/fixed by a conventional fixing apparatus.

FIG. 5 is an explanatory diagram illustrating a state where light is condensed by a fixing member and UV ink is cured/fixed in the fixing apparatus shown in FIGS. 1 to 3.

FIG. 6 is a schematic side view illustrating part of a printing unit and a fixing apparatus in a printing apparatus in a second embodiment.

FIG. 7 is a schematic side view illustrating part of a printing unit and a fixing apparatus in a printing apparatus in a third embodiment.

FIG. 8 is a schematic side view illustrating part of a printing unit and a fixing apparatus in a printing apparatus in a fourth embodiment.

FIG. 9 is a schematic perspective view showing a fixing apparatus in an example.

FIG. 10 is a schematic side view of the fixing apparatus shown in FIG. 9.

FIG. 11 is a schematic perspective view of the fixing apparatus shown in FIG. 9, which is illustrated from the rear side thereof.

FIGS. 12A and 12B are schematic side views schematically showing the positional relation at the time of measuring a light condensing effect of the fixing member in Example 1, FIG. 12A shows a case where a photo detector is disposed just below the fixing member, and FIG. 12B shows a case where the photo detector is disposed just below the fixing member and the fixing member is eliminated.

FIG. 13 is a diagram showing the result of measurement of the light condensing effect of the fixing member in Example 1.

FIGS. 14A and 14B are schematic side views schematically showing the positional relation at the time of measuring a light condensing effect of condensing unit in Example 2, FIG. 14A shows a case where the condensing unit is disposed, and FIG. 12B shows a case where the condensing unit is eliminated.

FIG. 15 is a diagram showing the result of measurement of the light condensing effect of the condensing unit in Example 2.

FIG. 16 is a schematic perspective view showing a state where a post card immediately after being printed is irradiated by UV light while being conveyed between a fixing member and a press roller to cure/fix UV ink on a printing side in Example 3.

FIG. 17 is a picture image on a printing side of a post card after a friction experiment conducted with a clock meter of Case 1 in Example 3.

FIG. 18 is a picture image on a printing side of a post card after a friction experiment conducted with a clock meter of Case 2 in Example 3.

FIG. 19 is a picture image on a printing side of a post card after a friction experiment conducted with a clock meter of Case 3 in Example 3.

FIGS. 20A and 20B are enlarged photographic pictures of a part subjected to friction in Case 1 shown in FIG. 17 in Example 3.

FIGS. 21A and 21B are enlarged photographic pictures of a part subjected to friction in Case 2 shown in FIG. 18 in Example 3.

FIGS. 22A and 22B are enlarged photographic pictures of a part subjected to friction in Case 3 shown in FIG. 19 in Example 3.

FIG. 23 is a schematic side view illustrating a belt conveying unit.

### BEST MODE FOR CARRYING OUT THE INVENTION

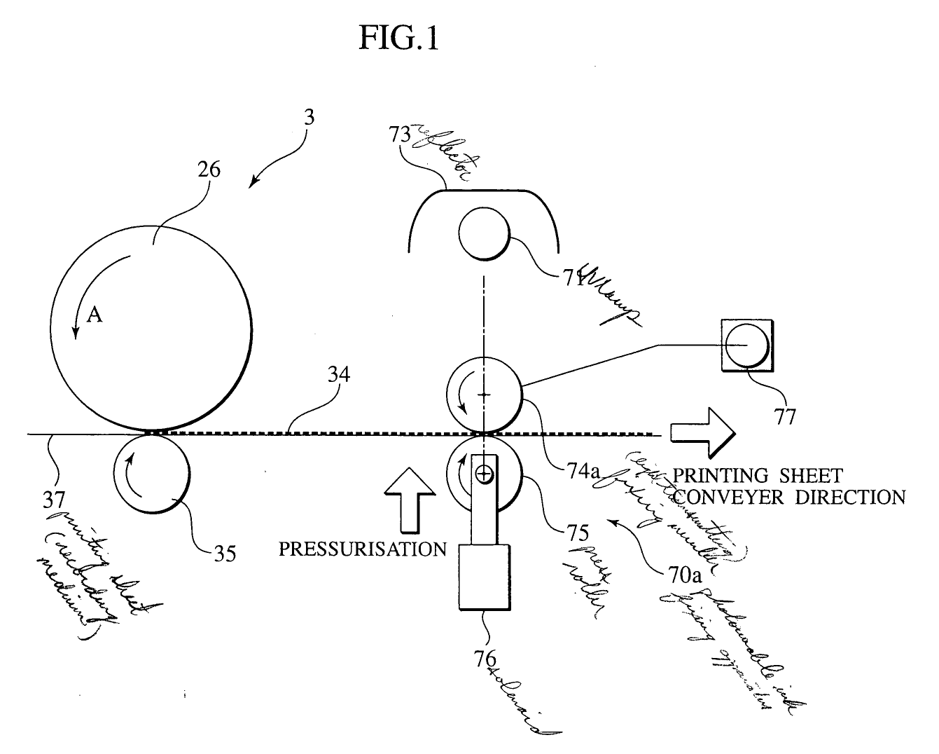

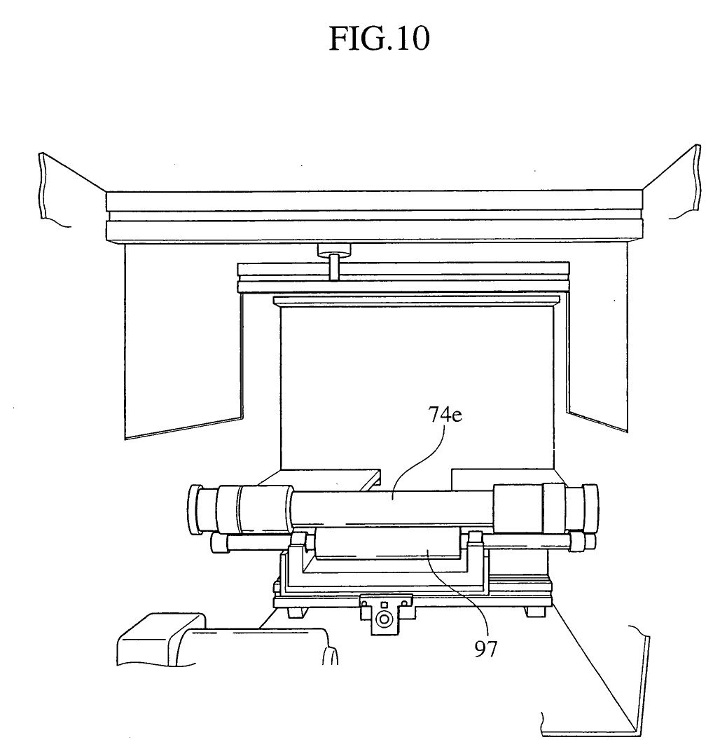

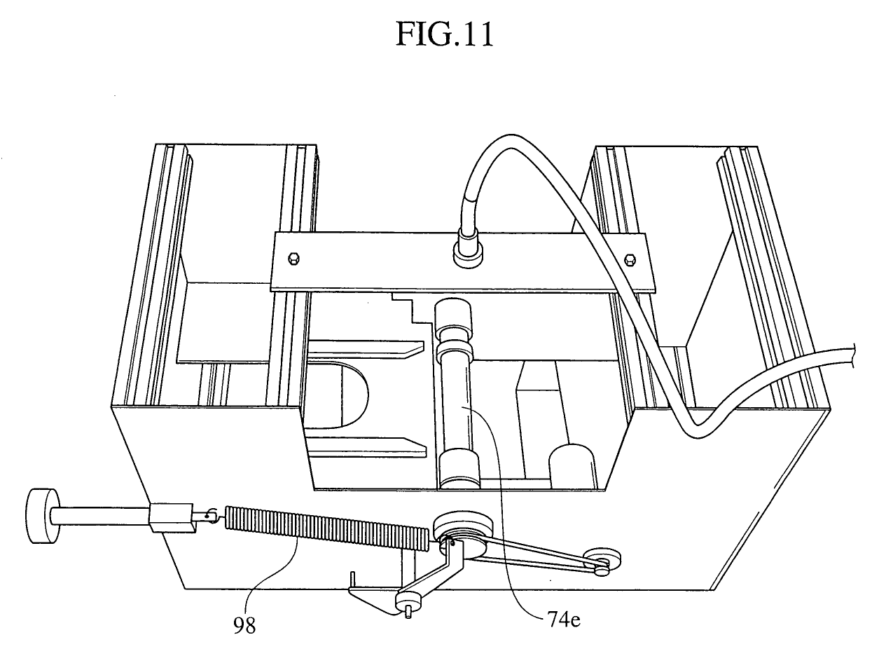

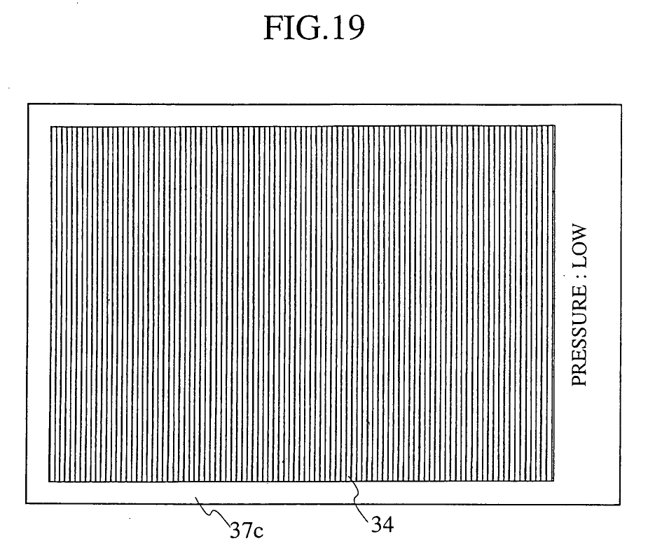

Embodiments of the present invention will be described in detail hereinbelow by properly referring to FIGS. 1 to 23. The same or equivalent reference numerals are designated to the same or equivalent parts and components in the drawings and repetitive description will not be given or will be simplified.

### First Embodiment

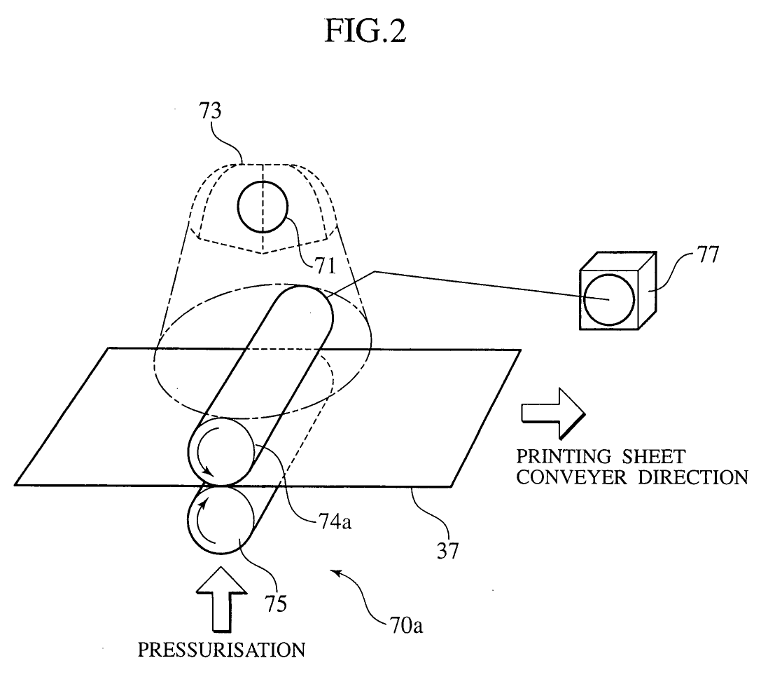

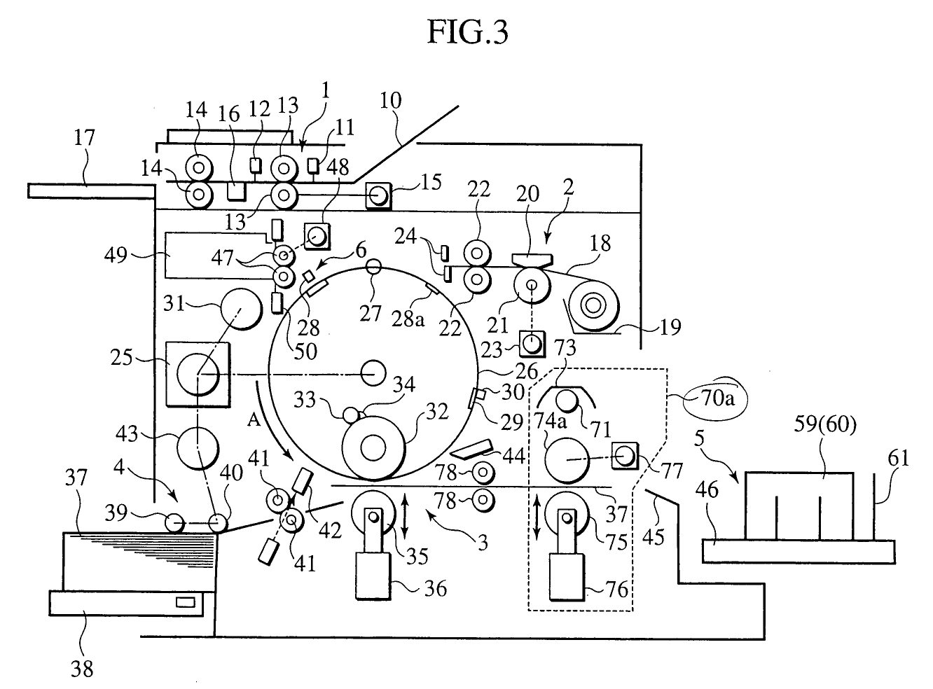

A photocurable ink fixing apparatus 70a of a first embodiment is disposed, for example, at the rear part of a printing unit 3 of a stencil printing apparatus as shown in FIG. 3. FIG. 1 is a schematic side view showing the fixing apparatus 70a and part of the printing unit 3 of the stencil printing apparatus shown in FIG. 3, and FIG. 2 is a schematic perspective view of the fixing apparatus 70a.

### Configuration of Stencil Printing Apparatus

As shown in FIG. 3, the stencil printing apparatus in the first embodiment has, as main components, an original read-out unit 1, a stencil making unit 2, a printing unit 3, a paper feeding part 4, a paper conveyer part 5, and a stencil disposal part 6. The fixing apparatus 70a is disposed at the rear part of the printing unit 3.

The original read-out unit 1 has an original setup stand 10 on which an original to be printed is mounted, reflection-type original sensors 11 and 12 for detecting the presence or absence of the original on the original setup stand 10, a pair of original conveying rollers 13 and 14 for conveying the original on the original setup stand 10, a stepping motor 15 for driving rotary the pair of original conveying rollers 13 and 14, a contact-type image sensor 16 for optically reading an image of the original conveyed by the pair of original conveying rollers 13 and 14 and converting read image data into an electric signal, and an original ejecting tray 17 on which the original to be ejected from the original setup stand 10 is mounted. The original mounted on the original setup stand 10 is conveyed by the pair of original conveying rollers 13 and 14 and an image of the conveyed original is read by the image sensor 16.

The stencil making unit 2 has an original housing 19 for housing a rolled long stencil sheet 18, a thermal head 20 disposed on the conveyance downstream side of the original housing 19, a platen roller 21 disposed in a facing position of the thermal head 20, a pair of original feeding rollers 22 disposed on the conveyance downstream side of the thermal head 20 and the platen roller 21, a light pulse motor 23 for rotary driving the platen roller 21 and the original feeding rollers 22, and a cutter 24 disposed on the conveyance downstream side of the pair of original feeding rollers 22. The long stencil sheet 18 is conveyed by the rotation of the platen roller 21 and the original feeding rollers 22. Dotted heating elements of the thermal head 20 selectively generate heat on the basis of image data read by the image sensor 16, thereby thermally performing the stencil sheet 18 to make a perforated stencil sheet. The processed original stencil sheet 18 is cut with the cutter 24, thereby preparing the stencil sheet 18 having a predetermined length.

The printing unit 3 has: a printing drum (master cylinder) 26 whose outer peripheral part has a porous structure and is made of an ink transmitting member and which rotates in the direction of the arrow A in FIG. 3 by the driving force of a main motor 25; a stencil sheet clamp segment 27 provided on the outer peripheral side of the printing drum 26 and clamping the tip of the stencil sheet 18; an original checking sensor 28 for detecting whether or not the stencil sheet 18 winds around the outer peripheral side of the printing drum 26 by detecting a detection piece 28a of the printing drum 26; a reference position detecting sensor 30 for sensing a reference position of the printing drum 26 by detecting a detection piece 29 of the printing drum 26; and a rotary encoder 31 for detecting rotation of the main motor 25. On the basis of a detection output of the reference position detecting sensor 30, the rotation position of the printing drum 26 is detected by sensing an output pulse of a rotary encoder 31.

The printing unit 3 also has a squeegee roller 32 disposed on the inside of the printing drum 26 and a doctor roller 33 disposed in the proximity of the squeegee roller 32. In an outer peripheral space surrounded by the squeegee roller 32 and the doctor roller 33, ultraviolet-curing radical polymerization ink (hereinbelow, UV ink) 34 which cures due to a chemical change caused by irradiation of ultraviolet rays is accumulated. The UV ink 34 adhered around the rotating squeegee roller 32 passes through the gap between the squeegee roller 32 and the doctor roller 33, thereby adhering only the UV ink 34 having predetermined film thickness onto the squeegee roller 32, and the UV ink 34 having the predetermined film thickness is supplied to the inner face of the printing drum 26. A press roller 35 is provided in a position facing the squeegee roller 32 and in an outer peripheral position of the printing drum 26. The press roller 35 is configured displaceably between a press position in which the outer peripheral side of the printing drum 26 is pressed by the driving force of a solenoid device 36 and a standby position apart from the outer peripheral side of the printing drum 26. The press roller 35 displaces from the standby position to the press position synchronously with paper feeding operation of the paper feeding part 4, is positioned in the press position only when a printing sheet 37 passes below the printing drum 26 and, at the other times, positioned in the standby position.

The tip of the perforated stencil sheet 18 conveyed from the stencil making unit 2 is clamped by the stencil sheet clamp segment 27. In the clamped state, the printing drum 26 is rotated, the stencil sheet 18 winds around the outer peripheral side of the printing drum 26, and printing sheet 37 conveyed from the paper feeding part 4 synchronously with rotation of the printing drum 26 is pressed against the stencil sheet 18 on the printing drum 26 by the press roller 35, thereby transferring the UV ink 34 from perforations in the stencil sheet 18 onto the printing sheet 37 and printing an image.

The paper feeding part 4 has: a paper feed stand 38 on which the printing sheets 37 are stacked; primary paper feed rollers 39 and 40 for conveying only the uppermost printing sheet 37 from the paper feed stand 38; a pair of secondary paper feed rollers 41 for conveying the printing sheet 37 conveyed by the primary paper feed rollers 39 and 40 to the space between the printing drum 26 and the press roller 35 synchronously with the rotation of the printing drum 26; and a paper feed sensor 42 for detecting whether or not the printing sheets 37 is conveyed between the pair of secondary paper feed rollers 41. The rotation of the main motor 25 is selectively transmitted to the primary paper feed rollers 39 and 40 via a paper feed clutch 43.

The printing sheet 37 subjected to printing process in the printing unit 3 is separated from the printing drum 26 by a paper separating claw 44 and conveyed to the fixing apparatus 70a by a pair of conveying rollers 78. The UV ink 34 printed on the printing sheet 37 is cured/fixed by the fixing apparatus 70a. The detailed configuration of the fixing apparatus 70a will be described later.

The printing sheet 37 on which the UV ink 34 of the printing side is cured/fixed by the fixing apparatus 70a is transferred from a conveyance path 45 to a paper receiving tray 46 of the paper conveyer part 5. On the paper receiving tray 46, a pair of side fences 59 and 60 and an end fence 61 as paper ejection fences are provided.

The stencil disposal part 6 has: a pair of stencil discharge rollers 47 for conveying the perforated stencil sheet 18 while separating the perforated stencil sheet 18 from the printing drum 26; a stencil discharge motor 48 for driving rotary the stencil discharge rollers 47; a stencil discharge box 49 for housing the stencil sheet 18 conveyed from the stencil discharge rollers 47; and a stencil discharge sensor 50 for detecting whether or not the stencil sheet 18 has been conveyed to the stencil discharge box 49 by the stencil discharge rollers 47.

### Configuration of Fixing Apparatus

As shown in FIGS. 1 to 3, the fixing apparatus 70a according to the first embodiment has: a UV lamp (light source) 71 which is disposed at the rear stage of the printing unit 3 and irradiates UV light (light for fixation) to the printing side (recording side) of the printing sheet (recording medium) 37 on which an image is printed with the UV ink (photocurable ink) 34; a fixing member 74a which is disposed between the UV lamp 71 disposed above the conveyance path of the printing sheet 37 and the printing sheet 37 and can transmit the UV light; a motor 77 for rotary driving the fixing member 74a; and a press roller (conveying member) 75 which is disposed so as to face the fixing member 74a over the conveyance path of the printing sheet 37 and nips the printing sheet 37 conveyed along the conveyance path in cooperation with the fixing member 74a by the driving force of a solenoid device 76 (pressurizing unit). The printing sheet 37 is conveyed along the conveyance path while being nipped by the press roller 75 and the fixing member 74a by the driving force of the solenoid device 76, and the contact part between the fixing member 74a and the printing side of the printing sheet 37 is irradiated by UV light transmitting the fixing member 74a, thereby curing/fixing the UV ink 34 printed on the printing side of the printing sheet 37.

The UV lamp 71 is a lamp for emitting UV light and, for example, a xenon flash lamp, a metal halide lamp, a mercury lamp, or the like is used. The UV lamp 71 may be a tubular lamp, a bulb lamp, or a lamp having any other shape. It is desirable to provide a reflector 73 to efficiently reflect the UV light emitted from the UV lamp 71 toward the printing side of the printing sheet 37. The UV lamp 71 is disposed on the outside of the fixing member 74a and irradiates UV light, which incident on the fixing member 74a and transmitting the fixing member 74a, to the contact part between the fixing member 74a and the printing side of the printing sheet 37.

Each of the fixing member 74a and the press roller 75 has a cylindrical shape as shown in FIG. 2. The rotary shaft of each of the fixing member 74a and the press roller 75 extends in the direction orthogonal to the conveyance direction of the printing sheet 37 and has overall length which is equal to or larger than the width in the conveyance direction of the printing sheet 37. With the configuration, the fixing member 74a and the printing side of the printing sheet 37 are closely in line contact with each other in the overall width direction.

The fixing member 74a is made of a material which can transmit light in the ultraviolet light waveband, the visible light waveband, and the infrared light waveband, that is, light in a frequency band from 200 nm to 1,300 nm. More preferably, the fixing member 74a is made of, for example, quartz glass which can transmit light in a frequency band including the ultraviolet light waveband from 200 nm to 500 nm.

The fixing member 74a is constructed so as to be rotatable around its rotary shaft as a center and is rotary driven at a peripheral velocity equivalent to the conveyance speed of the printing sheet 37 by the motor 77 to convey the printing sheet 37.

The fixing apparatus 70a constructed as described above conveys the printing sheet 37 while nipping the printing sheet 37 by the fixing member 74a and the press roller 75 by the driving force of the solenoid device 76 and irradiates the UV light, which transmits the fixing member 74a, to the contact part between the fixing member 74a and the printing side of the printing sheet 37. Since the UV ink 34 on the printing sheet 37 of the part nipped by the press roller 75 and the fixing member 74a is adhered to the fixing member 74a, air (oxygen) of the contact part is blocked and the UV ink 34 is directly irradiated by UV light. Consequently, as compared with the case where the UV ink 34 is cured/fixed in the air (oxygen), the UV light irradiation energy of the UV lamp 71 required for curing/fixing can be reduced.

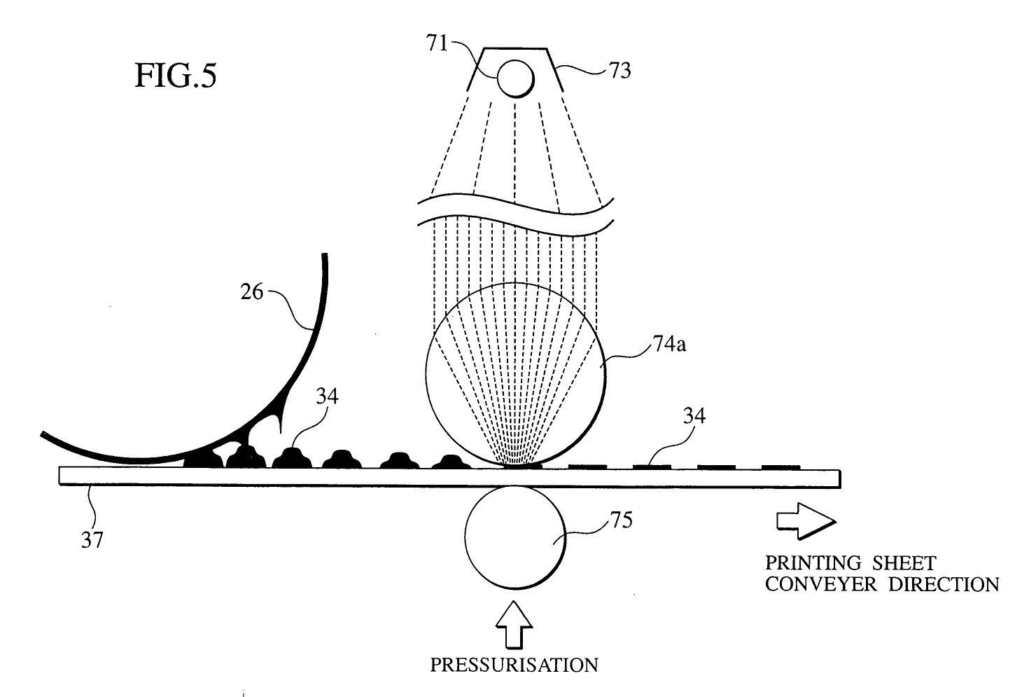

Further, as shown in FIG. 5, the fixing member 74a has a cylindrical shape producing a light condensing effect. Consequently, UV light emitted from the UV lamp 71 and incident on the fixing member 74a is condensed in a portion around the contact part between the fixing member 74a and the printing sheet 37 on the side opposite to the incident side. Synergistically with an effect of blocking oxygen by the press roller 75 and the fixing member 74a, curing/fixing of the UV ink 34 is promoted more efficiently. Therefore, by setting the same irradiation time, the UV ink 34 can be cured/fixed even by using the UV lamp 71 of smaller irradiation energy. In the case of using the UV lamp 71 such as a metal halide lamp having high irradiation energy which is the same as that of the conventional one, the UV ink 34 can be cured/fixed in shorter time than before. Therefore, the cost of light generation, cooling, and the like can be reduced more than before.

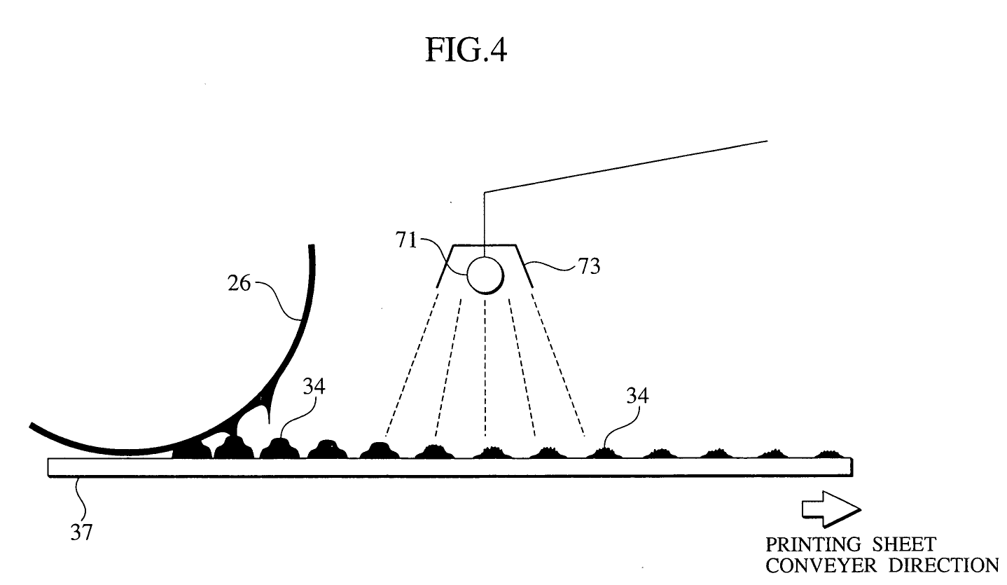

Furthermore, as shown in FIG. 4, heretofore, the UV ink 34 printed on the printing side of the printing sheet 37 is cured/fixed by being irradiated by UV light emitted directly from the UV lamp 71 disposed above the conveyance path of the printing sheet 37 and UV light reflected by the reflector 73. The cured/fixed state on the printing side of the UV ink 34 is influenced by a transfer state of the printing side of the UV ink 34, smoothness of the printing side, and the like, so that variations such as roughness often occur.

In contrast, the fixing apparatus 70a of the embodiment conveys the printing sheet 37 while nipping the printing sheet 37 by the fixing member 74a and the press roller 75 and irradiates the contact part between the fixing member 74a and the printing side of the printing sheet 37 by UV light emitted from the UV lamp 71 which is disposed on the outside of the fixing member 74a and transmits the fixing member 74a, thereby curing/fixing the UV ink 34 on the printing side of the printing sheet 37. Consequently, the UV ink 34 can be smoothly cured/fixed without being influenced by the transfer state of the printing side of the UV ink 34, smoothness of the printing side, and the like. Thus, visual quality of a printed sheet also improves.

### Second Embodiment

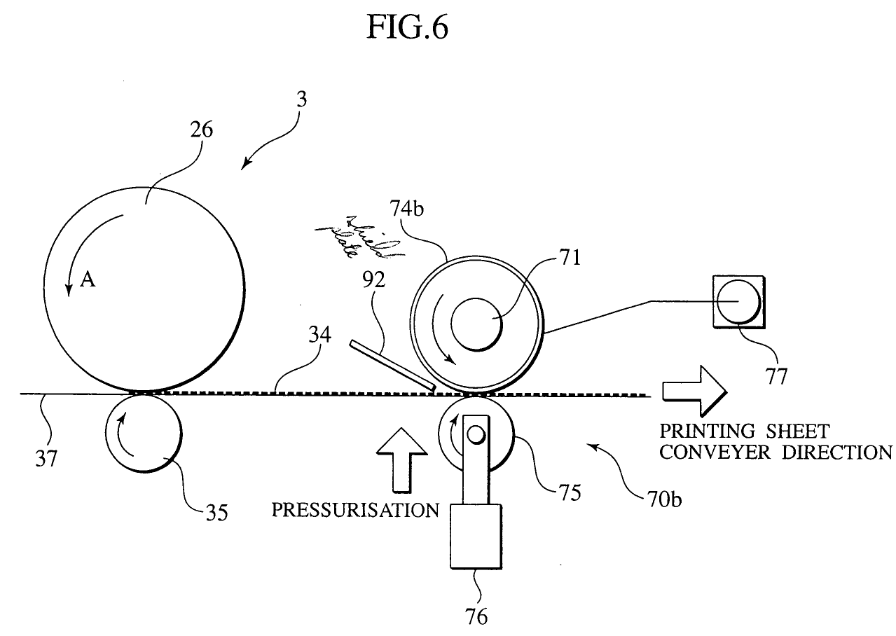

As shown in FIG. 6, a fixing apparatus 70b according to a second embodiment has: the UV lamp (light source) 71 which is disposed at the rear stage of the printing unit 3 and irradiates UV light (light for fixation) to the printing side (recording side) of the printing sheet (recording medium) 37 on which an image is printed with the UV ink (photocurable ink) 34; a fixing member 74b which is disposed on the conveyance path of the printing sheet 37 and can transmit the UV light; the motor 77 for rotary driving the fixing member 74b; and the press roller (conveying member) 75 which is disposed so as to face the fixing member 74b over the conveyance path of the printing sheet 37 and nips the printing sheet 37 conveyed along the conveyance path in cooperation with the fixing member 74b by the driving force of the solenoid device 76 (pressurizing unit). Further, a shield plate 92 for preventing UV light from leaking to the printing sheet 37 before the UV ink 34 is cured/fixed is also provided.

The fixing member 74b is formed in a cylindrical shape by, for example, quartz glass that can transmit UV light, and the UV lamp 71 is disposed in the cylinder. By conveying the printing sheet 37 on the conveyance path while nipping the printing sheet 37 by the fixing member 74b and the press roller 75 by the driving force of the solenoid device 76 and irradiating the contact part between the fixing member 74b and the printing side of the printing sheet 37 by UV light which transmits the fixing member 74b, the UV ink 34 printing on the printing side of the printing sheet 37 can be cured/fixed.

Since the UV ink 34 on the printing sheet 37 of the part nipped by the press roller 75 and the fixing member 74b is tightly adhered to the fixing member 74b, air (oxygen) of the contact part is blocked and the UV ink 34 is directly irradiated by UV light. Consequently, as compared with the case where the UV ink 34 is cured/fixed in the air (oxygen), the UV light irradiation energy required for curing/fixing can be reduced. Further, the irradiation distance between the UV lamp 71 and the printing sheet 37 can be shortened by disposing the UV lamp 71 in the fixing member 74b, so that the irradiation energy of the UV lamp 71 can be reduced.

### Third Embodiment

A third embodiment is provided to increase the efficiency of the first embodiment. UV light to be incident on the fixing member 74a is enlarged to or more than a light reception area of the fixing member 74a, that is, the range of the diameter, the incident angle of the UV light incident on the fixing member 74a is made larger, and the light condensing point is moved more to the outer periphery of the fixing member 74a, thereby increasing the UV light emitted to the contact part between the fixing member 74a and the printing side of the printing sheet 37.

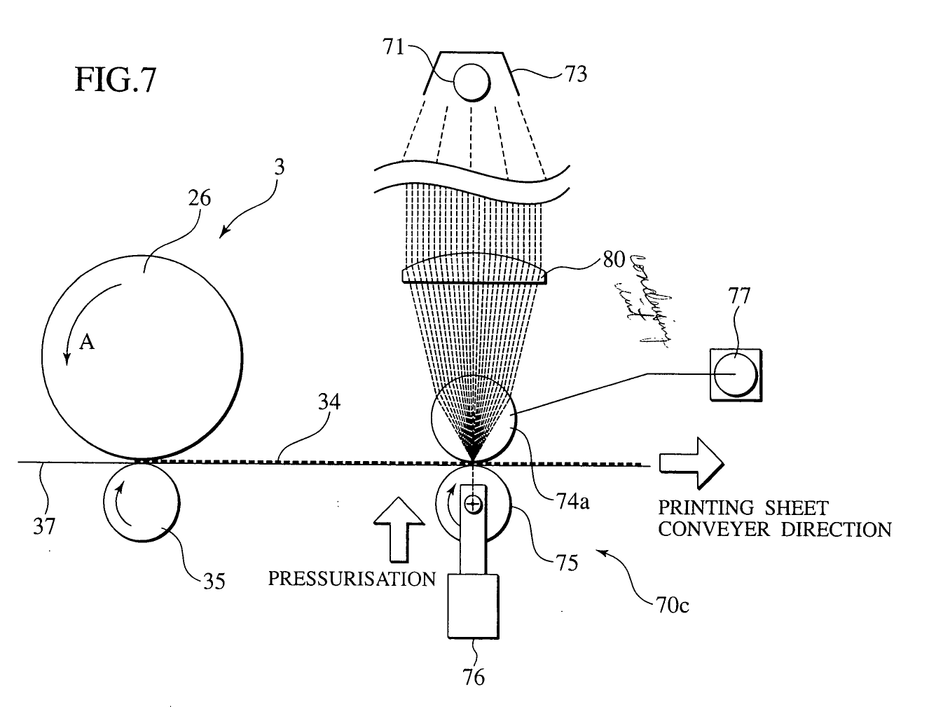

That is, a fixing apparatus 70c is obtained by adding a condensing unit 80 to the fixing apparatus 70a according to the first embodiment as shown in FIG. 7. The rest members of the third embodiment are the same as the fixing apparatus 70a according to the first embodiment, accordingly the detailed description will not be repeated.

The condensing unit 80 is mounted between the UV lamp 71 and the fixing member 74a, refracts and condenses UV light emitted radially from the UV lamp 71, and makes the UV light incident on the fixing member 74a at an angle larger than that of the first embodiment. With the configuration, the condensing unit 80 increases the UV light incident on the fixing member 74a and changes the incident angle of the UV light incident on the fixing member 74a at a larger angle, so that the light condensing point (focal point) is moved more to the outer periphery of the fixing member 74a, thereby increasing the UV light emitted to the contact part between the fixing member 74a and the printing side of the printing sheet 37.

In a manner similar to the first embodiment, the UV ink 34 on the printing sheet 37 of the part nipped by the press roller 75 and the fixing member 74a is tightly adhered to the fixing member 74a, so that air (oxygen) of the contact part is blocked and UV light of energy density higher than that of the first embodiment is emitted. Thus, the UV light irradiation energy of the UV lamp 71 required for curing/fixing can be reduced.

### Fourth Embodiment

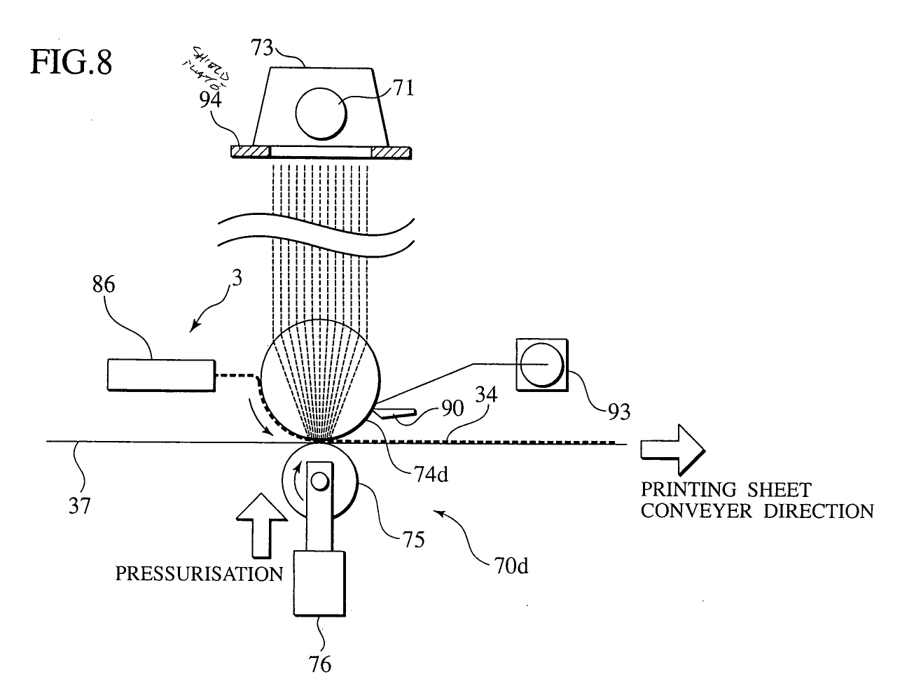

FIG. 8 is a diagram schematically showing an embodiment of a printing apparatus according to the present invention. The printing apparatus shown in FIG. 8 includes the printing unit 3 having an ink jet head 86 for jetting the UV ink 34 and a fixing apparatus 70d.

The fixing apparatus 70d has: the UV lamp (light source) 71 which is disposed at the rear stage of the ink jet head 86 and irradiates UV light (light for fixation) to the contact part between the fixing member 74d having an outer peripheral surface on which an image is formed with the UV ink (photocurable ink) 34 and the printing side (recording side) of the printing sheet (recording medium) 37 on which the image formed on the outer peripheral surface of the fixing member 74d is transferred; and a press roller (conveying member) 75 which is disposed so as to face the fixing member 74d over the conveyance path of the printing sheet 37 and nips the printing sheet 37 conveyed along the conveyance path in cooperation with the fixing member 74d by the driving force of the solenoid device (pressurizing unit) 76. The fixing apparatus 70d also has the reflector 73 for efficiently reflecting UV light emitted from the UV lamp 71 and a shield plate 94 for regulating UV light emitted from the UV lamp 71 from leaking to an unnecessary space.

Each of the fixing member 74d and the press roller 75 has a cylindrical shape. The rotary shaft of each of the fixing member 74d and the press roller 75 extends in the direction orthogonal to the conveyance direction of the printing sheet 37 and has overall length which is equal to or larger than the width in the conveyance direction of the printing sheet 37. Each of the fixing member 74d and the press roller 75 is supported so as to be rotatable around the rotary shaft as a center.

Further, the fixing member 74d is formed in a cylindrical shape by using, for example, quartz glass or the like which can transmit the UV light, and the outer peripheral side of the fixing member 74d on the upstream side of the part nipped by the fixing member 74d and the press roller 75 and a nozzle of the ink jet head 86 are disposed in facing positions.

At the time of performing printing operation, the fixing member 74d is rotary driven in the direction of the arrow (counterclockwise direction) shown in FIG. 8 by a motor 93, and the UV ink 34 is jetted from the ink jet head 86 onto the outer peripheral side of the fixing member 74d to form an image (reversed image) on the outer peripheral side of the fixing member 74d on the upstream side of the nipped part of the press roller 75. In this case, the ink jet head 86 and the motor 93 are controlled by a not-shown controller, and the fixing member 74d is rotary driven in accordance with the operation of the ink jet head 86. The ink jet head 86 may be of a serial head type or a line head type. Since the technique of the ink jet head 86 is known, it will not be described here.

By nipping the printing sheet 37 by the press roller 75 driven by the solenoid device 76 and the fixing member 74d and making the fixing member 74d and the printing sheet 37 in tightly contact with each other, the image formed in the outer peripheral side of the fixing member 74d is transferred to the printing sheet 37.

At this time, the printing sheet 37 is conveyed by rotary driving the fixing member 74d by the motor 93 while nipping the printing sheet 37 by the fixing member 74d and the press roller 75, and the contact part between the fixing member 74d and the printing side of the printing sheet 37 is irradiated by UV light which is incident on the fixing member 74d and transmits the fixing member 74d from the side opposite to the part nipped by the fixing member 74d and the press roller 75, thereby curing/fixing the UV ink 34 transferred on the printing side of the printing sheet 37.

The UV ink 34 which has not been transferred to the printing side of the printing sheet 37 out of the UV ink 34 jetted onto the outer peripheral side of the fixing member 74d is removed by a cleaner 90 which is in slide contact with the outer peripheral side of the fixing member 74d and is discharged to a not-shown waste ink discharge unit. To promote transfer or removal of the UV ink 34, a fix preventing film having a UV light transmitting property may be formed on the outer peripheral side of the fixing member 74d.

### Fixing Apparatus for Experiments

To further deepen the understanding of the apparatus and method of fixing photocurable ink and the printing apparatus according to the foregoing embodiments, results of experiments conducted by the inventor herein will be described.

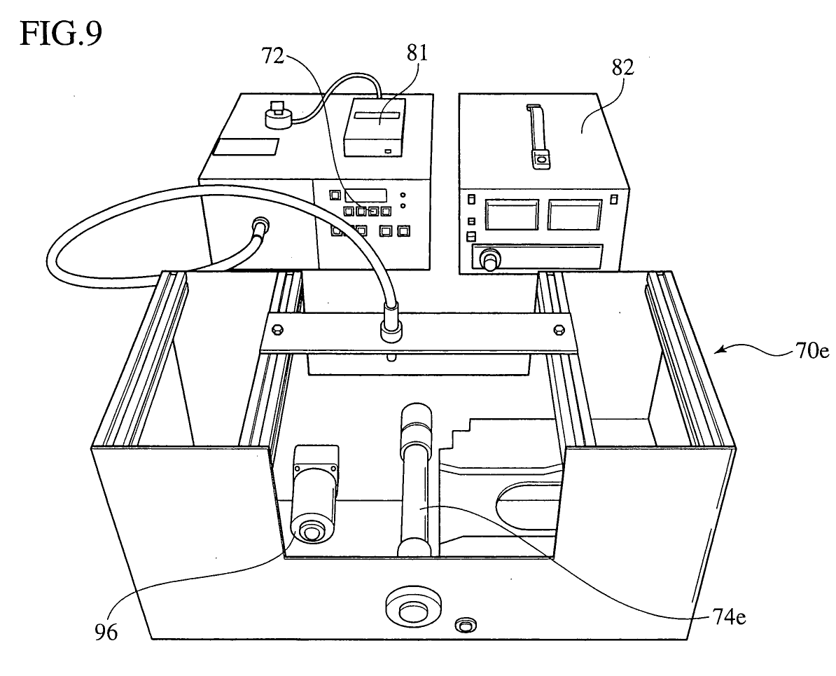

FIGS. 9 to 11 are schematic diagrams showing the configuration of a fixing apparatus 70e prototyped for experiments. The fixing apparatus 70e is constructed by an ultraviolet ray generator and an optical fiber and has: a UV generating apparatus 72 for emitting UV light generated by the ultraviolet ray generator from the tip of the optical fiber; a fixing member 74e which can transmit the UV light; a motor 96 for rotary driving the fixing member 74e; and a press roller 97 which is disposed so as to face the fixing member 74e and nips printing sheet conveyed on a conveyance path between the press roller 97 and the fixing member 74e by the driving force of a solenoid device 98. The fixing apparatus 70e also includes a power supply unit 82 and an UV sensor (UV actinometer) 81 constructed by a photo detector and a body.

As the UV sensor 81, the “UV-meter UIT-150” (Ushio Inc.) was used. As the UV generating apparatus 72, “Acticure Model A4000” (EFOS Inc.) was used. A quartz glass rod having a diameter of 30 mm was used as the fixing member 74e and the material of the press roller 97 is POM (Polyoxymethylene; polyacetal).

### Example 1

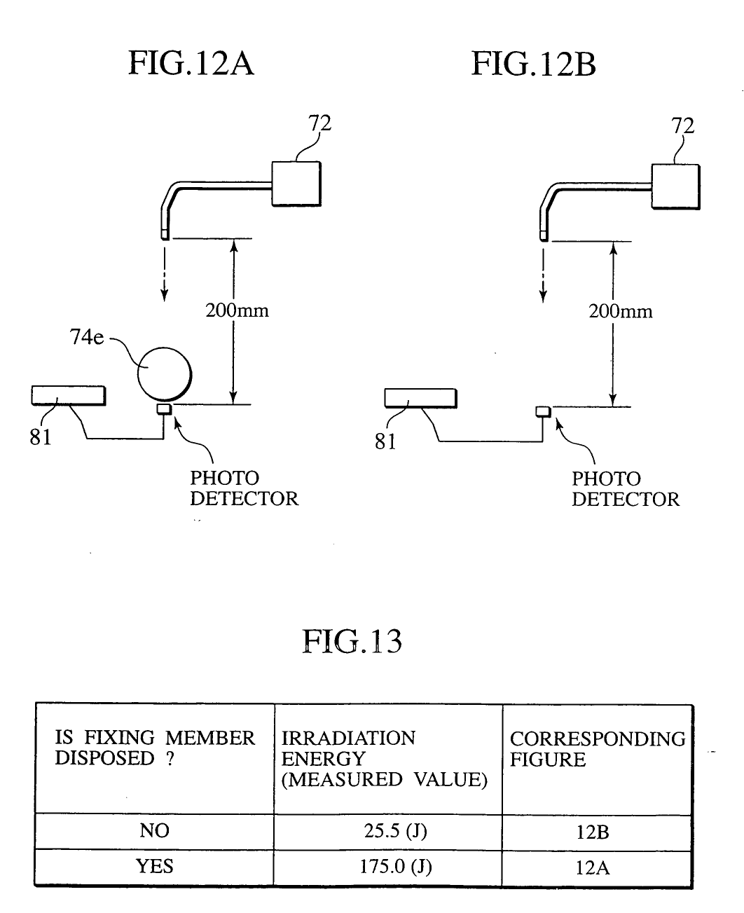

The irradiation energy of UV light in the case where, to examine the degree of condensation of UV light in the contact part of the fixing member 74e with the press roller 97, first, the press roller 97 was removed from the fixing apparatus 70e and, as shown in FIG. 12A, a photo detector is mounted in the nipped position of the fixing member 74e and the press roller 97. That is, the irradiation energy of UV light emitted from the tip of the optical fiber of the UV generating apparatus 72, transmitting the fixing member 74e, and condensed in the contact part between the fixing member 74e and the printing side of the printing sheet 37 was measured.

Further, as shown in FIG. 12B, the irradiation energy of UV light in the case where the photo detector was kept in such a state and the fixing member 74e was removed as shown in FIG. 12B, that is, the irradiation energy of UV light directly emitted from the tip of the optical fiber of the UV generating apparatus 72 was measured.

The results of measurement are as shown in FIG. 13. The irradiation energy of UV light which transmits the fixing member 74e and is received by the photo detector was 175.0 J (in the case of FIG. 12A) and, in contrast, the irradiation energy of UV light received directly by the photo detector in a state where the fixing member 74e is removed was 25.5 J (in the case of FIG. 12B).

Therefore, it is understood that, as shown in FIG. 5, the UV light emitted from the tip of the optical fiber of the UV generating apparatus 72 is condensed in the part nipped by the fixing member 74e and the press roller 97 and the irradiation energy increased by one digit because of the light condensing effect of the fixing member 74e having the cylindrical shape.

### Example 2

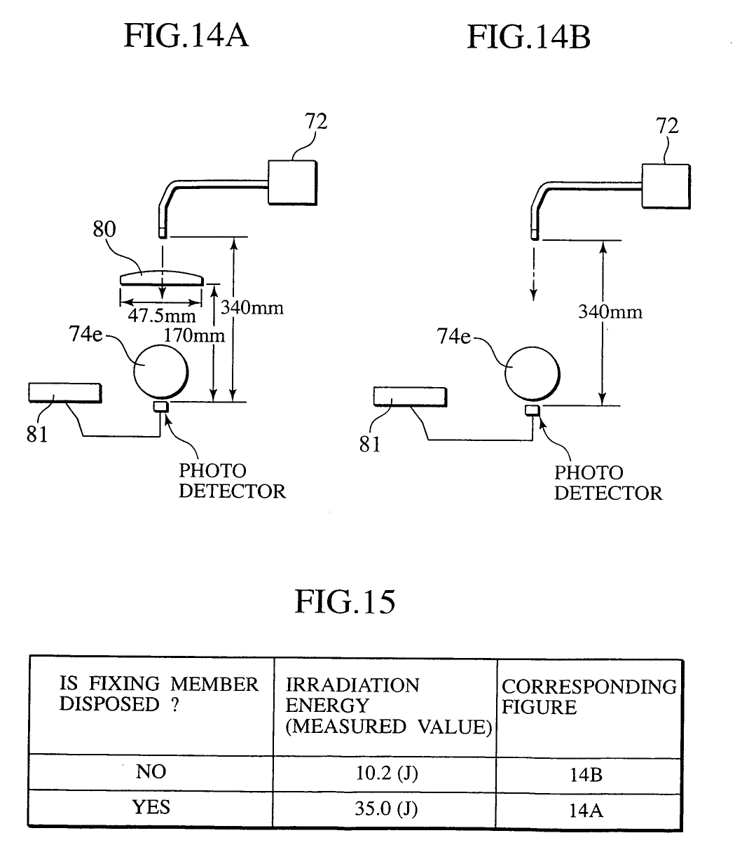

The irradiation energy of UV light was measured in the case where, to examine the effect of the condensing unit 80, the fixing apparatus 70e which is the same as that of Example 1 was used, the press roller 97 was removed, the condensing unit 80 was mounted as shown in FIG. 14A, and a photo detector was mounted in the nipped position of the fixing member 74e and the press roller 97. That is, the irradiation energy of the UV light emitted from the tip of the optical fiber of the UV generating apparatus 72, condensed by the condensing unit 80, and incident at an angle larger than the angle of incidence in the fixing member 74e in the case where the condensing unit 80 was not mounted transmitted the fixing member 74e and condensed in the contact part between the fixing member 74e and the printing side of the printing sheet 37 was measured.

Further, the irradiation energy of UV light was measured in the case where the fixing apparatus 70e and the photo detector were kept in such a state and the condensing unit 80 was removed as shown in FIG. 14B. That is, the irradiation energy of UV light emitted from the tip of the optical fiber of the UV generating apparatus 72, directly incident on the fixing member 74e, transmitting the fixing member 74e, and condensed in the contact part between the fixing member 74e and the printing side of the printing sheet 37 was measured.

The condensing unit 80 is a convex lens made of quartz glass and has a focal length of 770 mm, a diameter of 47.5 mm, and a length of 210 mm.

The results of measurement are as shown in FIG. 13. The irradiation energy of UV light received by the photo detector in the case where the condensing unit 80 is disposed was 35.0 J (in the case of FIG. 14A) and, in contrast, the irradiation energy of UV light received by the photo detector in the case where the condensing unit 80 was removed was 10.2 J (in the case of FIG. 12B).

Therefore, it is understood that by the light condensing effect of the condensing unit 80, the UV light emitted from the tip of the optical fiber of the UV generating apparatus 72 is condensed by the condensing unit 80 and is condensed in the part nipped by the fixing member 74e and the press roller 97, thereby increasing the irradiation energy.

### Example 3

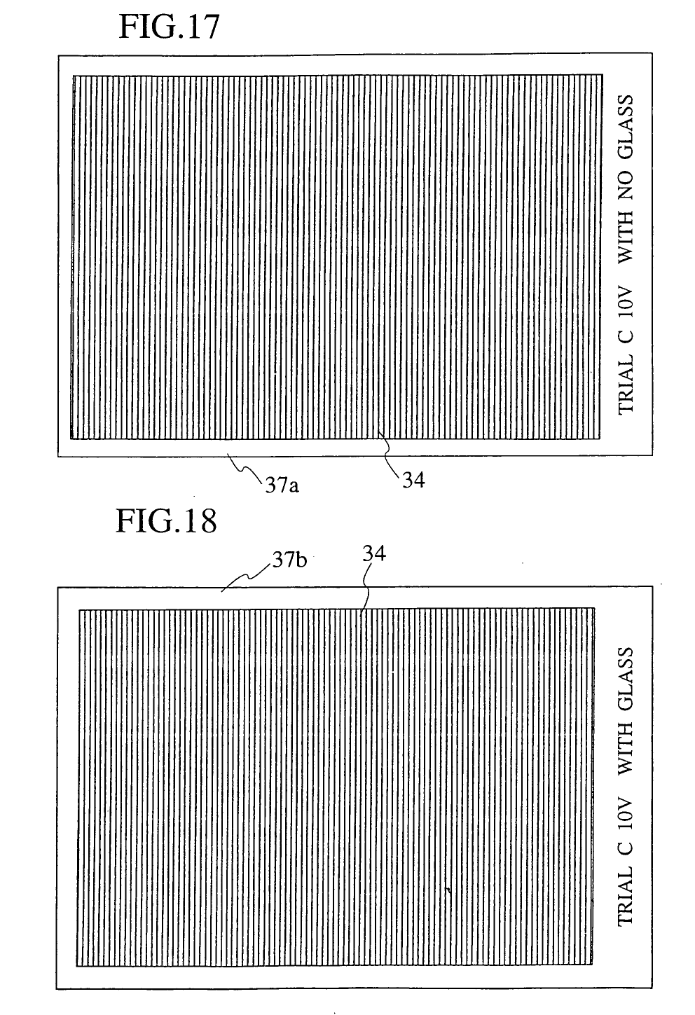

First, printing images as shown in FIGS. 17 to 19 were printed on post cards 37a, 37b, and 37c, respectively, by using the UV ink 34. As a printing apparatus, “RISO Meister CP150” (Riso Kagaku Corporation) was used.

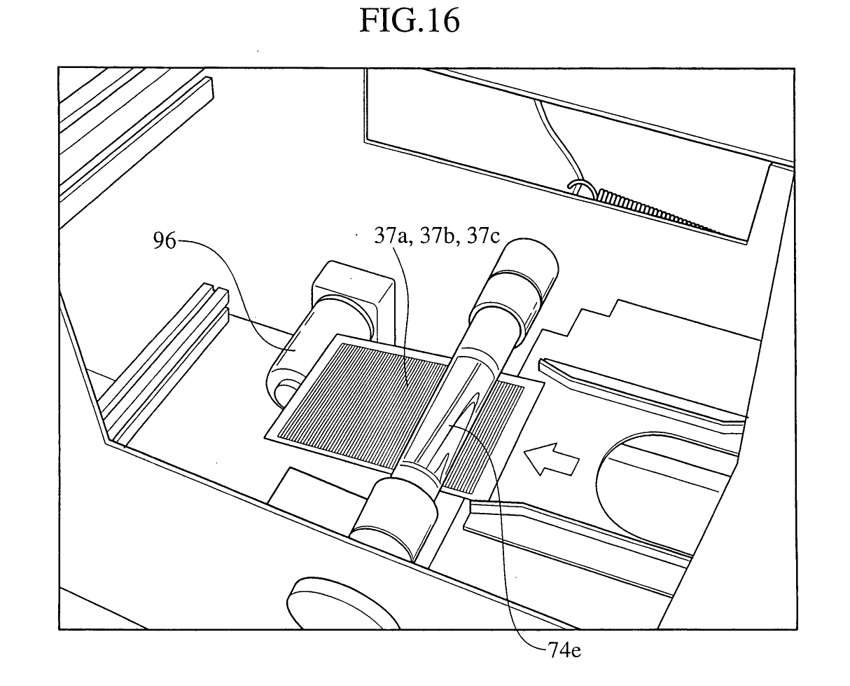

As shown in FIG. 16, by using the fixing apparatus 70e, the post cards 37a, 37b, and 37c immediately after printing were irradiated by UV light while being conveyed between the fixing member 74e and the press roller 97 under the conditions shown in Table 1 to cure/fix the UV ink 34 on the printing side of the post cards 37a, 37b, and 37c. The distance from the tip of the optical fiber of the UV generating apparatus 72 to the contact part between the fixing member 74e and the press roller 75 (the distance required for irradiating the overall length of the fixing member 74e with the UV light emitted from the tip of the optical fiber of the UV generating apparatus 72) was set to 200 mm.

TABLE 1

| | | IRRA- | PRESSURE | |
|---|---|---|---|---|
| | | DIATION | OF PRESS | |
| | CONVEYER | ENERGY | ROLLER | |
| | SPEED(M/S) | (J) | (kg · f) | REMARKS |
| Case 1 | 2.5 × 10⁻² | 23.2 | 0 | POST CARD |
| | | | | 37a |
| Case 2 | 2.5 × 10⁻² | 23.2 | 9.0 | POST CARD |
| | | | | 37b |
| Case 3 | 2.5 × 10⁻² | 23.2 | 5.0 | POST CARD |
| | | | | 37c |

In Table 1, “conveyer speed” is a speed of conveying the post cards 37a, 37b, and 37c by the fixing member 74e rotary driven by the motor 96, and “irradiation energy of UV light” is the irradiation energy of UV light emitted from the tip of the optical fiber of the UV generating apparatus 72 near the contact part between the fixing member 74e and the press roller 97 (the position obtained by moving the photo detector shown in FIG. 12A by 60 mm in the horizontal direction) and directly received by the photo detector. “Pressure of press roller” denotes a force of nipping the post cards 37a, 37b, and 37c of the press roller 97 in cooperation with the fixing member 74e.

A not-shown crockmeter made three round trips on the printing side of each of the post cards 37a, 37b, and 37c immediately after the UV ink 34 was cured/fixed to produce friction, and transfer and peeling-off states of the UV ink 34 were observed. As the crockmeter, “Crockmeter Model CM-1” (Atlas Electric Device Co.) was used.

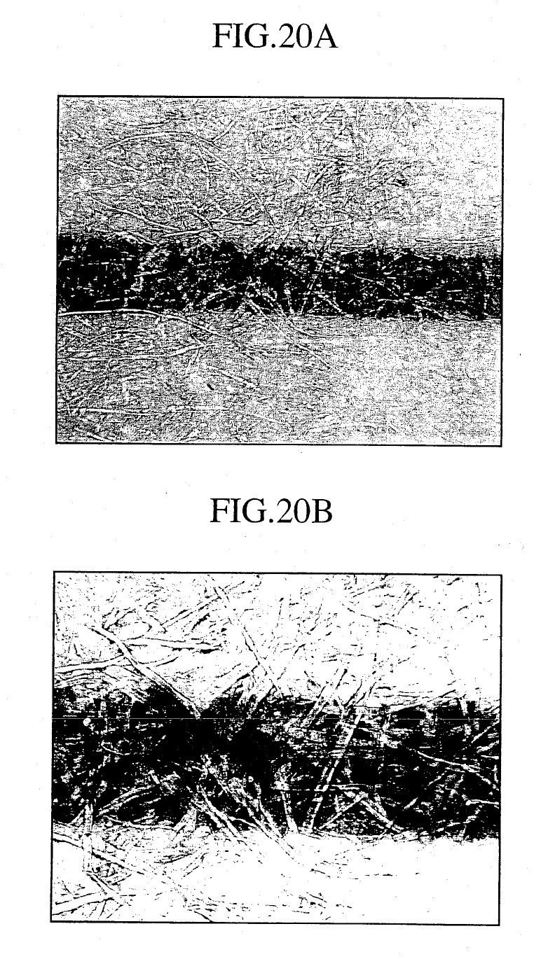

FIGS. 20 to 22 show enlarged photographic pictures of the part where friction was produced by the crockmeter of each of the post cards 37a, 37b, and 37c.

FIGS. 20A and 20B are enlarged photographic pictures of Case 1. It is seen that the UV ink 34 which is not cured/fixed peels off from fibers of the printing part of the post card 37a and is transferred to both ends of another fiber part due to the friction of the crockmeter.

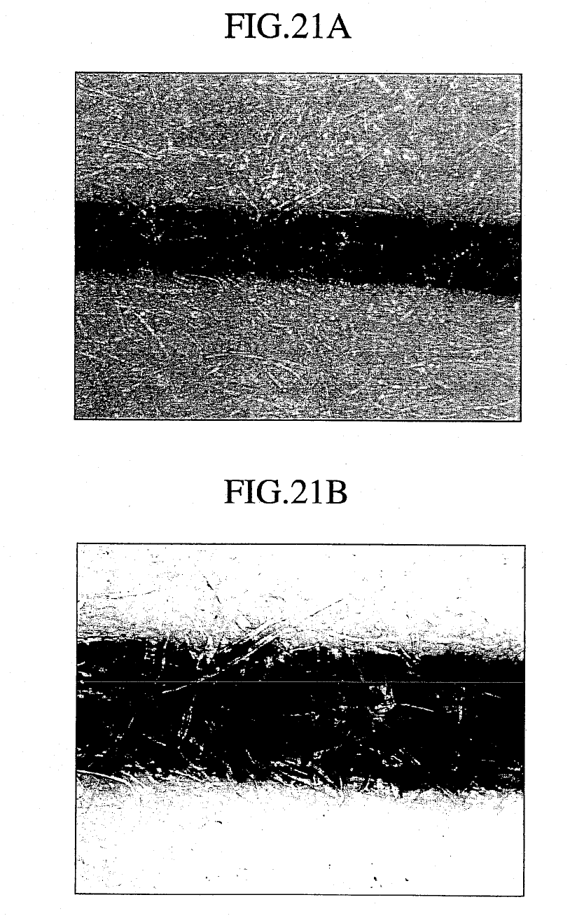

FIGS. 21A and 21B are enlarged photographic pictures of Case 2. Peeling-off of the UV ink 34 from the fibers of the printing part of the post card 37b and transfer to the other fiber parts due to the friction produced by the crockmeter is hardly seen, and the UV ink 34 is cured/fixed reliably.

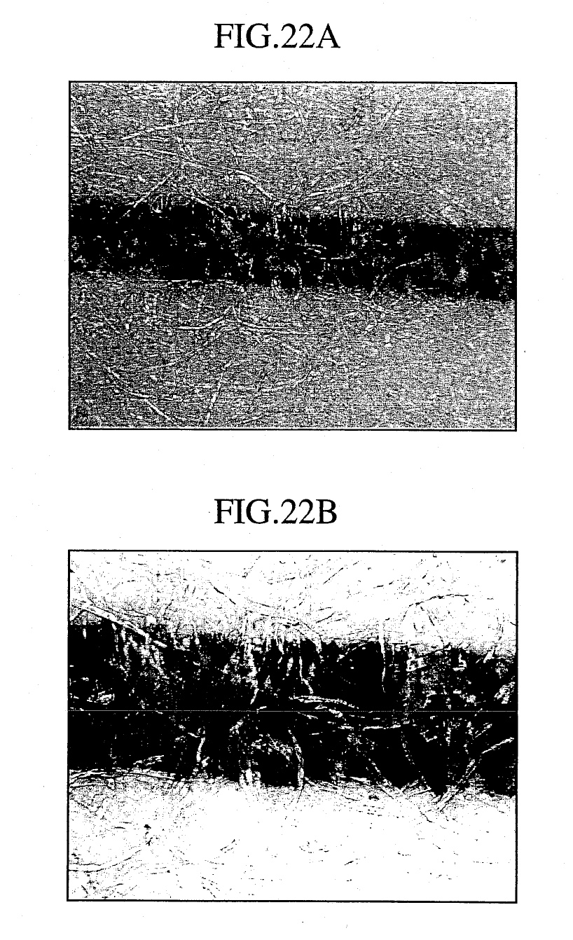

FIGS. 22A and 22B are enlarged photographic pictures of Case 3. Although the UV ink 34 is slightly peeled off from the fibers of the printing part of the post card 37c and transferred to other fiber parts, the peeling-off and transfer is less than that of Case 1.

From the above, it is understood that the stronger the force of nipping the post cards 37a, 37b, and 37c between the press roller 97 and the fixing member 74e (the press force of the press roller 97) is, the more the curing/fixing of the UV ink 34 is promoted.

Although the details of the first to fourth embodiments and examples have been described above, the invention can be carried out in other various modes without departing from the spirits or main features.

For example, in the foregoing embodiments, the configuration in which the fixing apparatus is assembled in the printing apparatus has been described but the fixing apparatus and the printing apparatus may be provided independently of each other.

Although the solenoid device 76 for driving the press roller 75 was described as a pressurizing unit for making the fixing members 74a, 74b, and 74c and the printing side of the printing sheet 37 come into tight contact with each other in the foregoing embodiment, alternately, the press roller 75 may be fixed and the fixing members 74a, 74b, and 74c and the printing side of the printing sheet 37 may come into tight contact with each other by a pressuring unit for driving the fixing members 74a, 74b, and 74c.

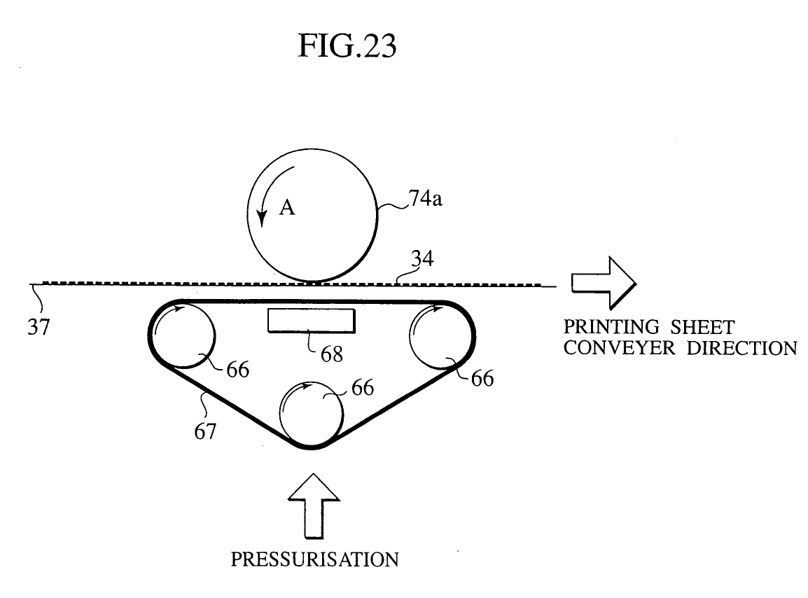

Although the press roller 75 was described as an example of the conveying member provided in the position facing the fixing members 74a, 74b, and 74c over the conveyance path of the recording medium, alternately, a belt conveying unit 65 constructed by a pulley 66, a belt 67, a supporter 68, and the like as shown in FIG. 23 may be provided.

As the printing unit 3 for printing the printing side of the printing sheet 37 with the UV ink 34, the stencil printing apparatus and the printing apparatus of the ink jet head type have been described. However, any printing apparatus or printing method can be used as long as it can print with UV inks. For example, the invention can be applied to a printing apparatus or printing method of intaglio, letterpress, lithography, or the like.

The foregoing embodiments are therefore to be considered in all respects as illustrative and not restrictive. The scope of the invention is indicated by the appended claims and is not limited by the foregoing description. Further, all modifications and changes which come within the meaning and scope of equivalency of the claims are intended to be embraced therein.

### INDUSTRIAL APPLICABILITY

According to the invention, in the printing process with the photocurable ink, the light irradiating energy required to cure and fix photocurable ink can be reduced.

1. An apparatus for fixing photocurable inks, comprising:
a light source for irradiating light for fixation to a recording side of a recording medium printed with photocurable ink;
a fixing member which is disposed in a conveyance path of the printed recording medium, is formed in a cylindrical shape, and can transmit the light for fixation;
a conveying member disposed so as to face the fixing member over the conveyance path; and
a pressurizing unit for nipping the fixing member and the conveying member,
wherein the recording medium is conveyed between the fixing member and the conveying member nipped by the pressurizing unit, the fixing member and the recording side of the recording medium are made come into tight contact with each other, and a contact part between the fixing member and the recording side of the recording medium is irradiated by the light for fixation which transmits the fixing member to thereby cure/fix the photocurable ink printed on the recording side of the recording medium.

2. The apparatus for fixing photocurable inks according to claim 1, wherein each of the fixing member and the conveying member is supported so as to be rotatable around its rotary shaft, the rotary shaft is disposed in a direction orthogonal to a conveyance direction of printed recording medium, and overall length in the rotary shaft direction is equal to or larger than width in the direction orthogonal to the conveyance direction of the recording medium.

3. The apparatus for fixing photocurable inks according to claim 1, wherein peripheral velocity of each of the fixing member and the conveying member is equal to conveyance speed of printed recording medium.

4. The apparatus for fixing photocurable inks according to claim 1, wherein the light source is disposed on the outside of the fixing member, and the light for fixation is incident on the fixing member from the side opposite to the nipped part of the fixing member and the conveying member, transmits the fixing member, and the contact part between the fixing member and the recording side of the recording medium is irradiated by the light for fixation.

5. The apparatus for fixing photocurable inks according to claim 1, further comprising a condensing unit which condenses the light for fixation,
wherein the condensing unit is disposed between the light source and the fixing member and condenses light for fixation emitted from the light source so as to be incident on the fixing member.

6. The apparatus for fixing photocurable inks according to claim 1, wherein the fixing member is formed in a cylindrical shape, the light source is disposed in the fixing member, and the contact part between the fixing member and the recording side of the recording medium is irradiated by the light for fixation which transmits the fixing member.

7. The apparatus for fixing photocurable inks according to claim 1, wherein the fixing member is made of a material which can transmit light whose wavelength lies from 200 nm to 1,300 nm.

8. The apparatus for fixing photocurable inks according to claim 1, wherein the fixing member is made of quartz glass.

9. The apparatus for fixing photocurable inks according to claim 1, further comprising:
a driving unit which rotates the fixing member,
wherein the fixing member conveys the recording medium by being rotary driven by the driving unit.

10. The apparatus for fixing photocurable inks according to claim 1, wherein
the light for fixation is ultraviolet light, and the photocurable ink is ultraviolet-curing radical polymerization ink.

11. A method for fixing photocurable inks, comprising the steps of:
conveying a recording medium printed with light-transmitting ink in a conveyance path while nipping a fixing member which is disposed in the conveyance path of printed recording medium, is formed in a cylindrical shape, and can transmit light for fixation and a conveying member disposed so as to face the fixing member over the conveyance path by a pressurizing unit, and making the fixing member and a recording side of the recording medium come into tight contact with each other; and
irradiating the light for fixation, which transmits the fixing member, to a contact part between the fixing member and the recording side of the recording medium to thereby cure/fix the photocurable ink printed on the recording side of the recording medium.

12. The method for fixing photocurable inks according to claim 11, wherein the light source is disposed on outside of the fixing member, and the light for fixation is incident on the fixing member from the side opposite to the nipped part of the fixing member and the conveying member, transmits the fixing member, and whereby the contact part between the fixing member and the recording side of the recording medium is irradiated by the light for fixation.

13. The method for fixing photocurable inks according to claim 11, wherein
a condensing unit for condensing the light for fixation is disposed between the light source and the fixing member, and
the condensing unit condenses the light for fixation emitted from the light source so as to be incident on the fixing member.

14. The method for fixing photocurable inks according to claim 11, wherein the contact part between the fixing member and the recording side of the recording medium is irradiated by the light for fixation which transmits the fixing member and is irradiated from the light source disposed in the fixing member formed in a cylindrical shape.

15. A printing apparatus comprising:
a printing unit which performs printing on a recording side of a recording medium with photocurable ink;
a light source for irradiating light for fixation to the recording side of the recording medium printed by the printing unit;
a fixing member disposed in a conveyance path of the printed recording medium, and which is formed in a cylindrical shape, and transmit the light for fixation;
a conveying member disposed so as to face the fixing member over the fixing member; and
a pressurizing unit for nipping the fixing member and the conveying member,
wherein the recording medium is conveyed between the fixing member and the conveying member nipped by the pressurizing unit, the fixing member and the recording side of the recording medium are made come into tight contact with each other, and a contact part between the fixing member and the recording side of the recording medium is irradiated by the light for fixation which transmits the fixing member to thereby cure/fix the photocurable ink on the recording side of the recording medium.

16. The printing apparatus according to claim 15,
wherein the printing unit forms an image with the photocurable ink on an outer peripheral side of the fixing member,
the recording medium is conveyed between the fixing member having the outer peripheral side on which the image is formed with the photocurable ink and the conveying member which are nipped by the pressurizing unit, and
while transferring the photocurable ink onto the recording side of the recording medium, the photocurable ink transferred on the recording side of the recording medium is cured/fixed.
